(19) United States
(12) Patent Application Publication
(10) Pub. No.: US 2013/0174078 A1
(43) Pub. Date: Jul. 4, 2013

(54) ARRANGEMENT FOR GRAPHICALLY VISUALIZING SYSTEM CONDITIONS

(71) Applicant: Jens-Harro Oechsner, Denkte OT Neindorf (DE)

(72) Inventor: Jens-Harro Oechsner, Denkte OT Neindorf (DE)

(73) Assignee: SIEMENS AKTIENGESELLSCHAFT, MUENCHEN (DE)

(21) Appl. No.: 13/822,357

(22) PCT Filed: Sep. 1, 2011
(86) PCT No.: PCT/EP11/65103

§ 371 Date: Mar. 12, 2013

(30) Foreign Application Priority Data
Sep. 14, 2010 (DE) 10 2010 045 464.8

(51) Int. Cl. G06F 3/0484

(52) U.S. Cl. CPC G06F 3/0484
USPC 715/771

(57) ABSTRACT

A configuration for graphically visualizing system conditions has at least one system containing a graphical output, in particular a train tracking system for railroad safety engineering. In order to adapt the graphic design to modern requirements without modifying the system software, the system is connected to a device for converting the graphical output into a higher-order language data format for generating an arbitrary graphic design.

The invention relates to an arrangement for graphically visualizing system conditions, having at least one system having a graphical output, in particular a train tracking system for railroad safety technology.

Information in the form of text and graphics is output at the graphical output, in particular a VGA/DVI/HDMI graphics card interface, and is visualized on a monitor. The information which is output and visible on the monitor corresponds solely to the graphic design created and defined in the operating system or program used.

The following description relates substantially to train tracking systems for railroad safety technology, without the invention being restricted to this use.

Train tracking systems, for example distance/time graphs, make it easier to detect delays and the risk of a collision. The clarity of the graphical visualization, that is to say the user interfaces, is of decisive importance in this case.

The product cycles are usually very long in the case of components for railroad safety technology, with the result that improvements which would be possible as a result of more modern software often cannot be implemented. As a result, the user interfaces in different systems are very different and also do not correspond to the latest standard.

Pixel-by-pixel adaptation of older graphical visualizations to the latest standard is extremely complicated and is associated with a high need for resources and is therefore scarcely practiced.

It would also be possible to revise the operating system or program in order to create modern intuitive user interfaces. However, this revision is difficult with older user interfaces and is often impossible on account of the system parameters, in particular the system performance with respect to the CPU, memory, EPROM or graphics system. In addition, knowledge of these systems is often no longer fully available. Poor or no documentation additionally makes the revision process more difficult. The implementation costs would therefore be incalculable and extremely high, especially since the structures for graphical output in old systems may be very different.

The invention is based on the object of specifying an arrangement for graphically visualizing system conditions, having at least one system having a graphical output, in particular a train tracking system for railroad safety technology, which arrangement makes it possible to modernize the graphic design in a simple manner and with a reasonable need for resources and without intervening in the existing software.

The object is achieved, according to the invention, by virtue of the fact that the system is connected to an apparatus for converting the graphical output into a higher-level language data format for generating any desired graphic design.

The high-level language conversion results in status-oriented format conversion, rather than pixel-oriented format conversion. The statuses of the system are transmitted only once. Only changes in the image contents are taken into account, resulting in very narrowband conversion. The need for resources, in particular the computer capacity required, is considerably lower than in the known pixel-oriented reformatting. As a result of the preferably standard-oriented conversion, the possibilities for creating the graphic design according to the requirements are fully available. In addition, the new graphic design can be adapted in an extremely flexible manner to changing conditions and stipulations.

Any types of systems with very different user interfaces can be modernized by the status-oriented conversion, a standard user interface becoming possible even in collaboration with systems from different manufacturers. The graphic design can be accordingly adapted without changing the system. The original software need not be changed since the existing graphical output is converted into the higher-level language data format. The conversion apparatus makes it possible to newly and intuitively create the graphical outputs of existing operating systems and programs. Necessary additions can also be added even though the system conditions and the system performance per se do not allow any graphical addition.

Data which have been transmitted once in the standardized high-level language are stored in the conversion apparatus, with only updates in this format having to be transmitted. The volume of data to be transmitted is accordingly low. Even complicated interfaces and interface components can be produced by means of simple commands. Data streams of a standardized graphical output are very narrowband as a result of the conversion into a higher-level language data format and can consequently be transmitted using any medium. Virtually real-time processing is possible. Any desired output formats, for example 4:3 displays, can be converted into any desired target formats, for example 16:9, 16:10 or 21:9.

According to claim 2, the apparatus is designed to convert the graphical outputs of a plurality of systems. Displays of a plurality of original systems can therefore be combined to form a standard graphic design. Combinations of partial displays of a plurality of original systems connected to the apparatus make it possible to visualize selected and actually required information in a new intuitive graphic design.

The apparatus according to claim 3 can also control at least one monitor. A combination of a plurality of monitors with an intuitive graphic design is preferably provided.

According to claim 4, the apparatus is provided with interface means for modifying the graphic design using the higher-level language data format. Additional, even external, information as well as displays and combinations can be supplemented or modified by the conversion apparatus by means of programming in the standardized high-level language or else any other high-level language, for example C++. As a result, a plurality of conversion apparatuses may also be connected in an arrangement in order to virtually superimpose particular additional calculations or displays on the graphic design. In addition, this multi-apparatus arrangement makes it possible to distribute power among a plurality of conversion apparatuses. Selected graphical outputs can be looped through, adapted, evaluated, converted or combined with external data in any desired manner. Superimposing the outputs makes it possible to implement the PiP (picture in picture) function. It is also possible to selectively emphasize or insert particular graphical outputs, in particular for emergency situations.

It is also possible to output the graphical output in the standardized high-level language as early as in the original system, the operating system or program then not carrying out any graphics preprocessing but rather using only the standardized high-level language of the conversion apparatus. This enables particularly fast graphical applications which are dependent only on the conversion apparatus. In this case, the original system does not require its own graphics preprocessing since this is carried out by the conversion apparatus.

The interface means according to claim 4 are designed, according to claim 5, to connect a microcontroller. The data outputs of microcontrollers or else electronic circuits which do not have a graphics card are converted into the desired user interface via the existing standardized interfaces, for example LAN, USB or UART, using the high-level language information of the conversion apparatus. In this case, the conversion apparatus creates user interfaces on the basis of the data which have already been output in the standardized high-level language via the microcontroller interface. In this case, the microcontroller interface may be a simple network connection of 1 Gbit/LAN. Since, in this case, there is no need to analyze user interfaces because the commands in the standardized high-level language have already been transmitted by the microcontroller, an interpreter of the conversion apparatus may have a very simple design or may even be dispensed with.

The invention is explained in more detail below using figures, in which:

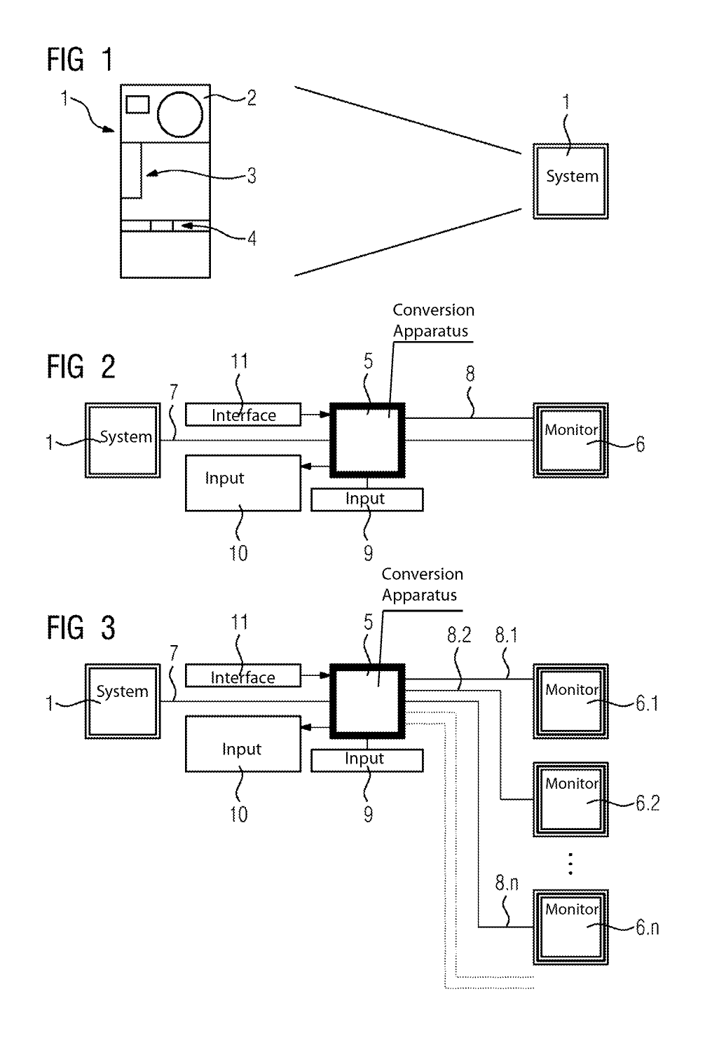

FIG. 1 shows system components, and

FIGS. 2-8 show different embodiments of an arrangement for graphically visualizing system conditions.

FIG. 1 shows the basic structure of a system 1, for example a train tracking system for railroad safety technology, the graphic design of which is intended to be adapted to current requirements for visualizing system conditions. At least one power supply unit 2, different connections 3, for example for a mouse, a keyboard or USB, and a graphics card connection 4 are usually present. This system 1 is illustrated in the form of a graphics card in the other figures.

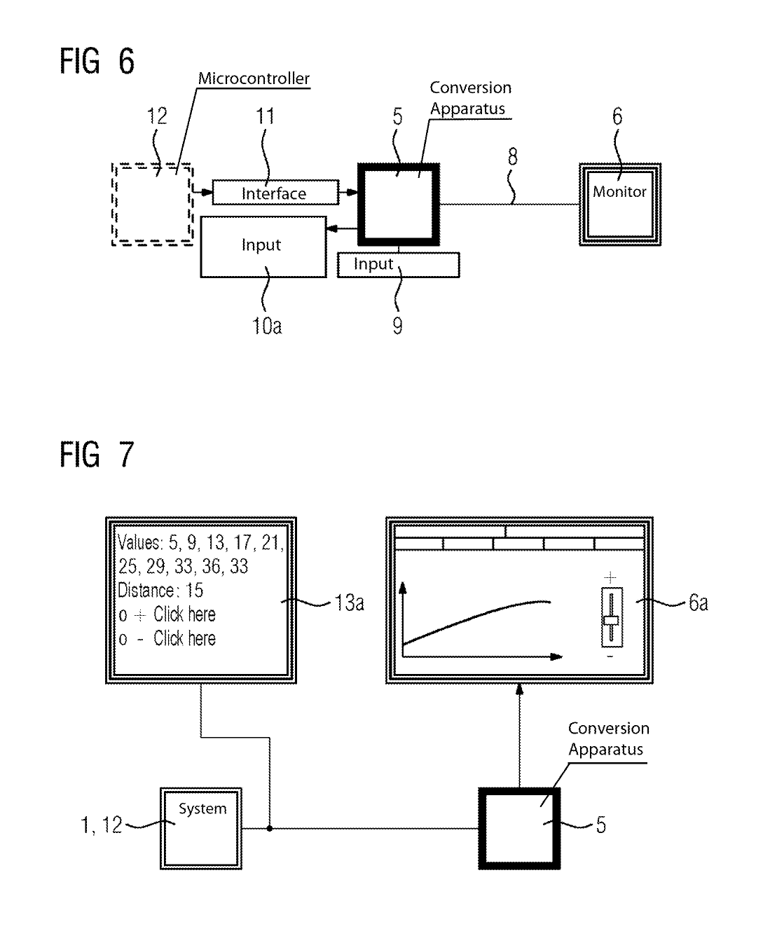

A first embodiment of the arrangement according to the invention substantially consists of the system 1, a conversion apparatus 5 and a monitor 6, as shown in FIG. 2. In this case, the graphical output 7 of the system 1 is connected to the conversion apparatus 5 which converts the graphical output 7 into an output 8 with a higher-level language data format, as a result of which a more modern graphic design can be displayed on the monitor 6. In this case, the conversion is carried out in a status-oriented manner, resulting in a narrowband data stream. Changes to the system software or the operating system are not required. The conversion apparatus 5 is also connected to first input means 9, in particular a mouse or a keyboard, for acting on the conversion apparatus 5 and to second input means 10, in particular a mouse or a keyboard, for acting on the system 1. In addition, the conversion apparatus 5 is provided with an interface 11 for connecting a microcontroller 12 (FIG. 6).

In the embodiment illustrated in FIG. 3, the conversion apparatus 5 produces a plurality of outputs 8.1, 8.2 . . . 8.n which control a plurality of monitors 6.1, 6.2 . . . 6.n. As a result, the graphical output 7 of the system 1 is split between a plurality of monitors 6.1, 6.2 . . . 6.n according to the requirements of the graphic design to be modernized.

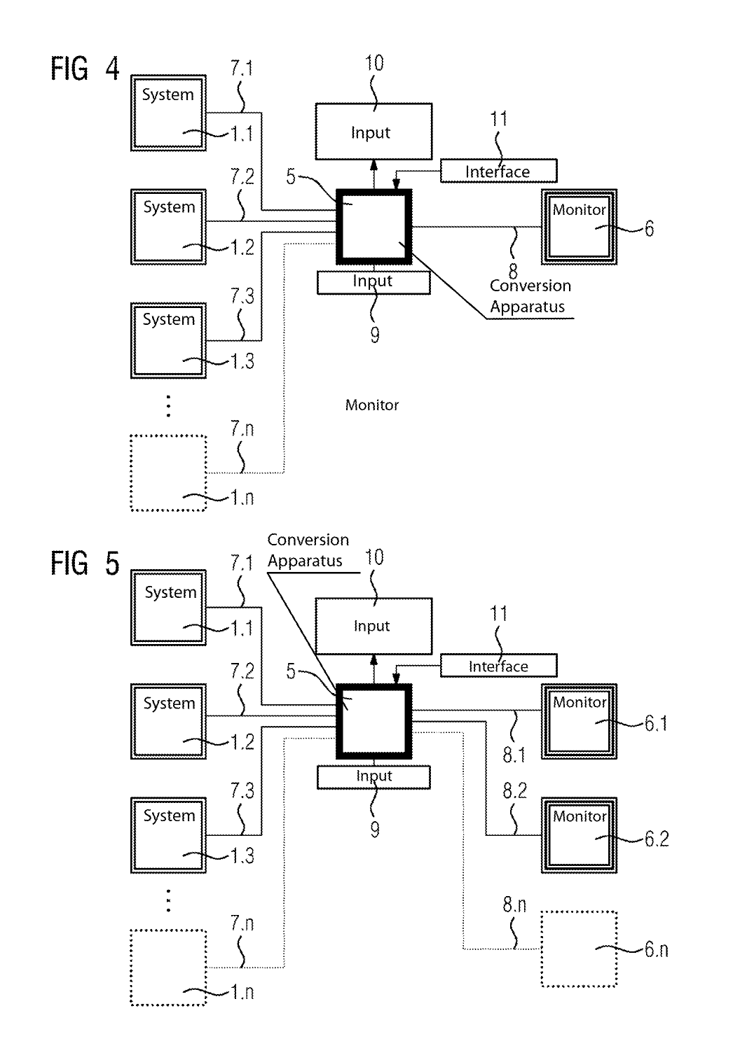

In another embodiment which is illustrated in FIG. 4, a combination of different data sources, rather than splitting, is aimed for, in contrast to FIG. 3. For this purpose, the graphical outputs 7.1, 7.2, 7.3 . . . 7.n of a plurality of systems 1.1, 1.2, 1.3 . . . 1.n are combined by the conversion apparatus 5 and are placed beside one another or are interleaved in one another in the new graphic design on the monitor 6 according to the desired layout.

FIG. 5 shows a variant of the arrangement according to the invention in which both the splitting according to FIG. 3 and the interleaving according to FIG. 4 are implemented. In this case, the conversion apparatus 5 is used to combine a plurality of graphical outputs 7.1, 7.2, 7.3 . . . 7.n of a plurality of systems 1.1, 1.2, 1.3 . . . 1.n and to control a plurality of monitors 6.1, 6.2 . . . 6.m, in which case the number m of monitors need not match the number n of systems.

In FIG. 6, the system 1 is replaced with the microcontroller 12 which, as the data source, is connected to the conversion apparatus 5 via the interface 11. The microcontroller 12 receives high-level language information from the conversion apparatus 5 via the second input means 10a, for example a serial interface or a USB interface, with the result that the graphics to be displayed on the monitor 6 can already be provided in the high-level language by the microcontroller 12. This embodiment can also be modified with a plurality of microcontrollers 12 and/or a plurality of monitors 6 in a similar manner to the embodiments in FIGS. 3 to 5.

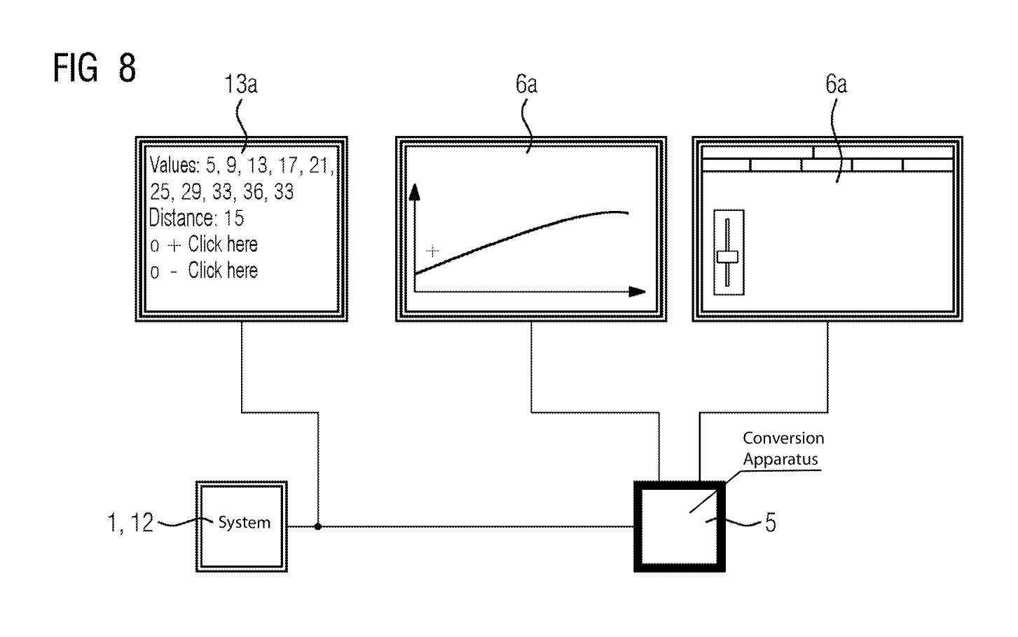

FIGS. 7 and 8 show two possibilities for converting a 4:3 monitor 13a, which is controlled by the system 1 or the microcomputer 12, into a 16:10 monitor 6a with a modernized graphic design. The source data are on one 16:10 monitor 6a according to FIG. 7 and are split between two 16:10 monitors 6a according to FIG. 8.

1-5. (canceled)

6. A configuration for graphically visualizing system conditions, the configuration comprising:
at least one system outputting a graphical output; and
an apparatus for converting the graphical output into a higher-level language data format for generating any desired graphic design, said system connected to said apparatus.

7. The configuration according to claim 6, wherein:
said system is one of a plurality of systems outputting graphical outputs; and
said apparatus converts the graphical outputs of said plurality of systems.

8. The configuration according to claim 6, further comprising at least one monitor controlled by said apparatus.

9. The configuration according to claim 6, wherein said apparatus has interface means for modifying a graphic design using the higher-level language data format.

10. The configuration according to claim 9, wherein said interface means are designed to connect to a microcontroller.

11. The configuration according to claim 6, wherein said at least one system is a train tracking system for railroad safety technology.

12. The configuration according to claim 9, further comprising a microcontroller connected to said interface means.
